(19) United States
(12) Patent Application Publication
(10) Pub. No.: US 2015/0342207 A1
(43) Pub. Date: Dec. 3, 2015

(54) PROCESS FOR PRODUCTION OF LOW MICROBIAL COUNT MILK PRODUCTS

(71) Applicant: DMK Deutsches Milchkontor GmbH, Zeven (DE)

(72) Inventor: Sven-Rainer Doring, Zeven (DE)

(21) Appl. No.: 14/724,228

(22) Filed: May 28, 2015

(30) Foreign Application Priority Data
May 28, 2014 (EP) 14 170 229.0

(51) Int. Cl. A23C 3/037; A23C 3/04; A23C 3/033

(52) U.S. Cl. CPC A23C 3/037; A23C 3/033; A23C 3/04

(57) ABSTRACT

A process is proposed for production of low microbial count whole milk products, in which
(a1) optionally, the milk product that is to be reduced in microbial count is subjected to a first heat pretreatment in a heat exchanger, and heated to temperatures in the range from 25 to 30° C.,
(a2) the optionally pretreated milk product is heated to temperatures of 50 to 75° C. by direct injection of superheated steam (“direct steam injection”, DSI) and pasteurized in the course of this, and
(a3) the pasteurized product is cooled by flash cooling.

A similar process for production of low microbial count skimmed milk products is likewise disclosed, which, as the most important intermediate step, additionally comprises separating off the cream.

### FIELD OF THE INVENTION

The invention relates to the field of milk products and relates to an improved process for microbe removal therefrom.

### PRIOR ART

Pasteurization is the short-time heating of liquid or pasty foods to temperatures up to 100° C. for killing microorganisms. It serves for, inter alia, preserving milk, fruit juices and vegetable juices and other liquids. Owing to the short time period of the heat action and the moderate temperature, the nutritional value, taste and consistency of the food are changed only insignificantly and nevertheless most of the food-spoilage organisms such as lactic acid bacteria and yeasts and many pathogenic bacteria such as salmonellae are reliably killed.

Heat-resistant bacterial spores, such as those of Clostridium botulinum, the causative organisms of paratuberculosis and also mould spores, survive this treatment, at least in part. For this reason, the microorganism content of the raw goods should be kept as low as possible. Pasteurization of milk it the best known, which milk for this purpose is heated to 72 to 75° C. for 15 to 30 seconds and thereafter is rapidly cooled again. Pasteurized milk remains palatable for about 6 to 10 days when stored unopened at 6 to 7° C. In Germany and the EU, according to the European Milk Hygiene Directive, pasteurization is required by law for all treated milk types except for raw milk and certified milk.

In the pasteurization of milk, plate heat exchangers are usually employed. However, owing to combustion processes, deposits form, on which, at temperatures of 30 to 55° C., thermoresistant microbes grow rapidly and readily; the same applies to dead spaces in the exchangers. The microbes can double in the course of 20 minutes in each case and thus populations of 6 million microbes/ml can easily form. Apart from the hygienic deficit, the microbes can lead, for example in cheese manufacture, to faults due to gas formation: entire cheeses in this case can inflate like air balloons. Owing to release of enzymes, sensory defects can also occur.

The usual pasteurization follows the scheme hereinafter: the raw milk is heated in the first heat exchanger for 30 to 45 seconds from 6 to 55° C. In the separator, then at this temperature in the course of 5 to 10 seconds, the cream is separated off. Then, the skimmed milk is heated in the course of 15 to 30 seconds to 72° C. and pasteurized at this temperature in the second heat exchanger. In the course of 45 to 60 seconds, the pasteurized milk is then cooled down again to 8° C. In total, the milk, however, remains for a relatively long period in the critical temperature window from 35 to 55° C., in which microbial growth takes place.

These microbes may not be killed by the pasteurization. The flow velocity in the components is restricted in such a manner that flushing out the microbes is not possible. An alternative would be an ultraheat treatment, but in this case the whey proteins would denature, and so this method also does not come into consideration.

Processes are known from the prior art in which some of the microbes are removed by microfiltration processes even before the pasteurization, and so give the impression that particularly low microbial count products would be obtained. For instance, as a representative of a great number of similar documents, EP 1656030 B1 (PARMALAT) discloses a process, for example, in which, before the pasteurization, filtration through a narrow-port membrane takes place, in which the permeate is further processed and the bacteria-loaded retentate is discarded. For the problem described at the outset, this is, however, no solution, since the low microbial count in the permeate remains so high that, under the conditions, which prevail during the treatment in the heat exchanger, the microbes can grow so intensively that again a considerable microbial loading is the consequence.

US 2002 012732 A1 (LINDQUIST) discloses a process in which a skimmed milk is subjected to a filtration and in this case a permeate and a retentate are obtained. Whereas the permeate is subjected to a heat treatment, the retentate is filtered a second time, and the resultant second permeate is added to the first permeate. However, the process proves much too complex in practice.

U.S. Pat. No. 6,372,276 B1 (LINDQUIST) relates to a process for generating a sterile milk, in which raw milk is first filtered, and the resultant permeate is then heat-treated in a plurality of stages. In this process procedure, however, frequent blockage of the membranes is observed, which leads to constant interruptions in the continuous process sequence, in addition, the microbial counts are insufficiently reduced. On the contrary, growth through the membranes is observed, and since no competing flora is present there, the microbial count increases exponentially.

The object of the present invention was therefore to provide an alternative process for the reliable removal of microbes from milk products, especially from whole and skimmed milk products, which process is free from the disadvantages described at the outset.

### DESCRIPTION OF THE INVENTION

A first subject matter of the invention relates to a process for production of low microbial count whole milk products, in which
(a1) optionally, the milk product that is to be reduced in microbial count is subjected to a first heat pretreatment in a heat exchanger, and heated to temperatures in the range from 25 to 30° C.,
(a2) the optionally pretreated milk product is heated to temperatures of 50 to 75° C. by direct injection of superheated steam (“direct steam injection” DSI) and pasteurized in the course of this, and
(a3) the pasteurized product is cooled by flash cooling.

A second subject matter of the invention relates to a similar process for production of low microbial count skimmed milk products, in which
(b1) optionally, the milk product that is to be reduced in microbial count is subjected to a first heat pretreatment in a heat exchanger, and heated to temperatures in the range from 25 to 30° C.,
(b2) the optionally pretreated milk product is heated to temperatures of 50 to 60° C. by a first direct injection of superheated steam (“direct steam injection”, DSI),
(b3) the cream is separated off,
(b4) the skimmed milk product is heated to temperatures of 50 to 75° C. by a second direct injection of superheated steam and pasteurized in the course of this, and
(b5) the pasteurized product is cooled by flash cooling.

Both processes can be operated continuously or batchwise.

The two processes are linked by the same inventive concepts, and differ only in that, in the first case a whole milk is obtained, and in the second a skimmed milk is obtained. In principle, however, the process is suitable for all other milk products which require pasteurization.

Surprisingly, it has been found that, by the combination of direct steam injection and flash cooling, the problem of the long residence time in the temperature range between 30 and 55° C., and in particular 35 to 50° C., which is advantageous for microbial growth, may be markedly reduced. Whereas customary pasteurization processes require a time between 1 and 2 minutes, this time period may be shortened by the factor 2 to 4 according to the present invention. In this manner, the microbial load of milk products can be markedly reduced.

### BRIEF DESCRIPTION OF THE DRAWINGS

The present invention will be described in greater detail with reference to the accompanying drawings in which

FIG. 1 schematically illustrates the principle of direct steam injection (DSI) in accordance with the present invention, including schematically illustrating structure of a DSI nozzle, and

FIG. 2 illustrates a flow chart for production of pasteurized skimmed milk products, with classical production illustrated on the left and production according to the invention illustrated on the right.

### DESCRIPTION OF THE PREFERRED EMBODIMENTS

### Preheating

In a first optional, although preferred, step, the raw milk, which customarily has a temperature between 5 and 10° C., is subjected to a preheating. This can be performed in customary plate heat exchangers, wherein a heating to about 25° C. takes place in the course of about 10 to about 30 seconds.

Direct Steam Injection (DSI)

The first essential step of the process according to the invention is shortening the critical heating operation, i.e. the slow passage through a temperature range in which mesophilic and thermophilic spores find optimal growth conditions, via a flat-type heating. This is achieved by the direct injection of hot or even superheated steam, which can have a temperature from 100 to about 250° C. Customarily, this is achieved with the aid of nozzles which are either immersed directly in the product or are built into an outlet line of the heat exchanger.

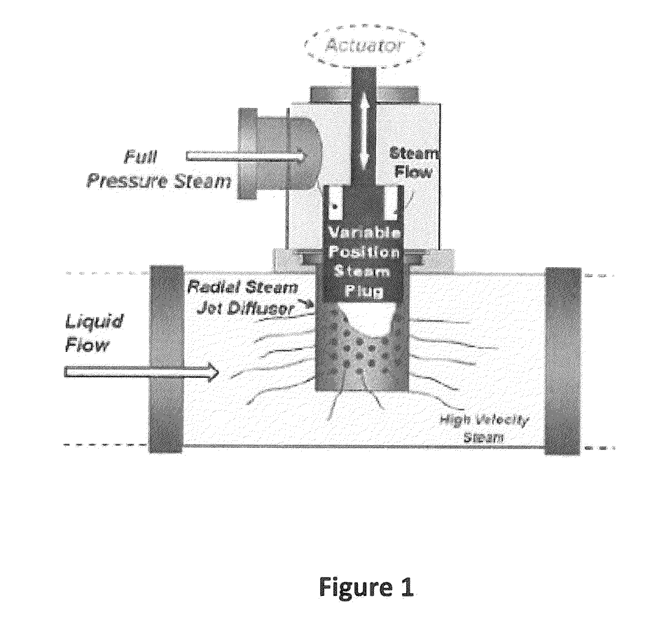

FIG. 1 illustrates the principle of DSI: a pressurized superheated steam jet is passed into a nozzle chamber and then expanded through a perforated tube (“radial steam jet diffuser”) into the liquid product that is to be heated. The high-pressure stream generates a radial heat-exchange field expanding at high velocity, as a result of which uniform heating of the product is achieved in very short times.

As described at the outset, the purpose is to adjust the milk product to an exact temperature in a very short time, preferably 1 to about 5 seconds, and in particular 1 to 2 seconds. For this purpose it is necessary to introduce a very precise amount of steam into the product at high velocity. If the amount of steam is controlled via a pressure-reduction valve, the velocity of the steam generally falls below the velocity of sound, which leads to the product not being heated rapidly enough. In order to prevent this, the steam in the context of the process according to the invention is preferably introduced under what is termed “choke-flow” conditions, because this permits steam to be introduced directly into the product that is to be heated even at ultrasound velocity. The phenomenon of increasing the steam velocity by generating a pressure difference using a special nozzle is understood hereunder, as is likewise shown schematically in FIG. 1. Using a pneumatically operated drive (“actuator”), a die (“variable position steam plug”) is moved up and down in a cylinder, in a similar manner to a piston, and as a result controls the amount of steam exactly. Corresponding components are obtainable commercially, for example from ProSonics.

The DSI does not require preheating of milk, as is described in the steps (a1) and (b1), and which are therefore stated to be optional. It is possible in principle to proceed directly from the cold raw milk. However, the temperature control becomes all the more precise the smaller the temperature differences are. If the raw milk is heated, as stated, to no more than 25° C. in the first step, it is below the temperature which is favourable for microbial growth, such that this is therefore not disadvantageous. A further aspect is that the heat transfer caused by the regenerative regions of a plate or tube heat exchanger is considerably more efficient.

The description of the DSI applies in each case to the steps (a2), (b2) and (b4).

Skimming

Skimming of the milk takes place when skimmed milk is to be produced. For this purpose, it has proved to be advantageous to separate off the cream (about 4% by weight of the total mass of raw milk) at temperatures that are not too high and in this case preferably do not exceed 60° C., because otherwise losses in quality occur. This process step can be carried out in standard separators which are adequately known from the prior art. In the milk industry, separators from GEA Westfalia Separator GmbH (http://www.westfalia-separator.com/de/anwendungen/molkereitechnik/milch-molke.html) are widely used. Corresponding components are also described, for example, in DE 10036085 C1 (Westfalia) and are best known to a person skilled in the art, in such a manner that, to carry these process steps, no explanations are required, since they are counted as part of the general specialist knowledge.

Flash Cooling

A second essential step of the process according to the invention is, during cooling, also to pass through the temperature range critical for microbial growth as rapidly as possible. For this purpose, flash cooling has proved to be particularly effective.

The expression flash cooling is taken to mean a process in which the hot liquid product is “flashed” under turbulent flow conditions into a reactor at a reduced pressure, in such a manner that the boiling point of the water is decreased below 30° C. For support, the shell of the flash reactor can be additionally further cooled. A corresponding process description relating to the cooling of a polymer preparation is described, for example, in EP 1116728 B1 (WOLFF CELLULOSICS).

Cooling the pasteurized whole milk or skimmed milk, as is provided in steps (a3) and (b5), requires about 1 to 5 seconds, wherein the final temperature is usually at about 25 to about 30° C.

Postcooling

If the shell of the flash reactor is additionally cooled, the exit temperature of the pasteurized milk can be below 10° C. In this case, a further cooling stage is not necessary. If the milk leaves the reactor at typically about 25° C., then, however, preferably a further cooling to about 5 to 10° C. follows, which again can proceed in a plate heat exchanger, because under these conditions no growth of unwanted microbes is observed.

### EXAMPLES

### Example 1

### Production of Pasteurized Skimmed Milk

Raw milk was cooled to 6° C. and heated to 25° C. in the course of 15 seconds using a plate heat exchanger. The preheated milk was heated to 55° C. by a first direct superheated steam injection in the course of 1 second and then passed into a separator in which the cream was separated off. The skimmed milk was heated to 72° C. in the course of 2 seconds by a second direct superheated steam injection and pasteurized. Then, the pasteurized milk was sprayed with turbulent flow into a reactor and the pressure in this case was decreased to the extent that the product cooled to 25° C. in the course of 5 seconds. The exiting product was then cooled to 8° C. in a plate heat exchanger. The resultant skimmed milk was virtually free from mesophilic and thermophilic spores.

### Comparative Example V1

### Production of Pasteurized Skimmed Milk

Raw milk was cooled to 6° C. and heated to 55° C. in the course of 40 seconds using a plate heat exchanger. The preheated milk was passed into a separator in which the cream was separated off. The resultant skimmed milk was heated to 72° C. in the course of 15 seconds in a second plate heat exchanger and pasteurized. Then, the pasteurized milk was cooled to 8° C. in a third heat exchanger. Although the resultant skimmed milk was within the EU specification, it had around 500 mesophilic and thermophilic spores per ml.

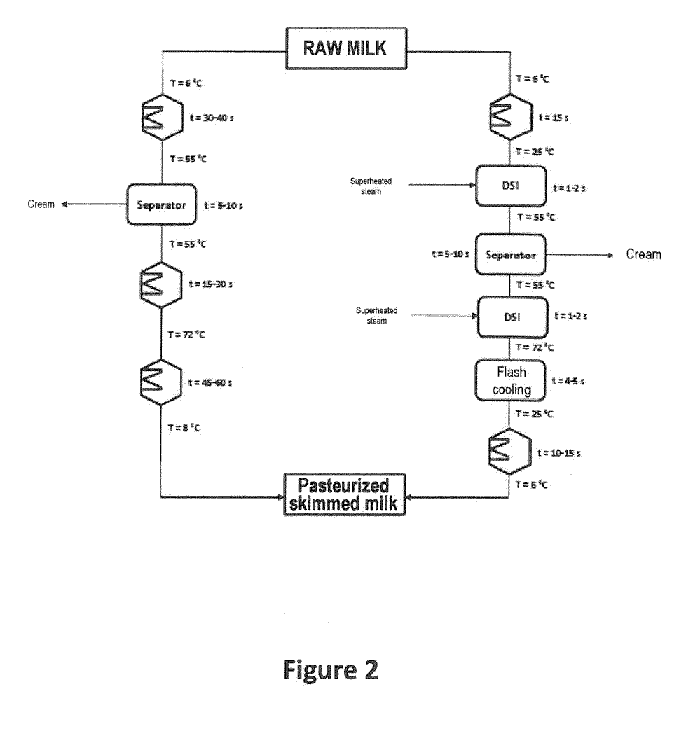

The two processes are compared with one another in FIG. 2 hereinafter once more with reference to a flow diagram.

1-10. (canceled)

11. Process for production of low microbial count milk products, comprising the following steps:
(a1) subjecting the milk product that is to be reduced in microbial count to a first heat pretreatment in a heat exchanger to a temperature in the range from 25 to 30° C.,
(a2) heating the pretreated product of step (a1) to a temperature of 50 to 75° C. by direct injection of supertreated steam to pasteurize the product in the course of this, and
(a3) cooling the pasteurized product of step (a2) by flash cooling.

12. The process of claim 11 which is carried out continuously.

13. The process of claim 11 which is carried out batchwise.

14. The process of claim 11 wherein the milk product is heated in a heat exchanger (step a1) for a period of about 10 to about 30 seconds.

15. The process of claim 11 wherein superheated steam is injected into the heat-pretreated product (step a2), which superheated steam has a temperature in the range from 100 to 250° C.

16. The process of claim 11 wherein superheated steam is injected into the heat-pretreated product (step a2) for a period of 1 to about 5 seconds.

17. The process of claim 11 wherein the pasteurized product (step a3) is cooled for a period of about 1 to 5 seconds.

18. The process of claim 11 wherein the pasteurized product (step a3) is cooled to a temperature of about 25 to about 30° C.

19. The process of claim 11 wherein the cooled product is finally cooled in a heat exchanger to a temperature of about 5 to about 10° C.

20. Process for production of low microbial count milk products, comprising the following steps:
(b1) subjecting the milk product that is to be reduced in microbial count to a first heat pretreatment in a heat exchanger to a temperature in the range from 2 to 30° C.,
(b2) heating the pretreated product of step (b1) to a temperature of 50 to 60° C. by direct injection of superheated steam,
(b3) separating off the cream from the product obtained in step (b2) to produce a skimmed milk,
(b4) heating the skimmed milk product of step (b3) to a temperature of 50 to 75° C. by a second direct injection of superheated steam to pasteurize the product in the course of this, and
(b5) cooling the pasteurized product of step (b4) by flash cooling.

21. The process of claim 20 which is carried of continuously.

22. The process of claim 20 which is carried out batchwise.

23. The process of claim 20 wherein the milk product is heated in a heat exchanger (step b1) for a period of about 10 to about 30 seconds.

24. The process of claim 20 wherein superheated steam is injected into the heat-pretreated products (steps b2, b4), which superheated steam has a temperature in the range from 100 to 250° C.

25. The process of claim 20 wherein superheated steam is injected into the heat-pretreated products (steps b2, b4) for a period of 1 to about 5 seconds.

26. The process of claim 20 wherein the pasteurized product (step b5) is cooled for a period of about 1 to 5 seconds.

27. The process of claim 20 wherein the pasteurized product (step b5) is cooled to a temperature of about 25 to about 30° C.

28. The process of claim 20 wherein the cooled product is finally cooled in a heat exchanger to a temperature of about 5 to about 10° C.
